(19) United States
(12) Patent Application Publication
(10) Pub. No.: US 2024/0408627 A1
(43) Pub. Date: Dec. 12, 2024

(54) BELL CUP, AND ROTARY ATOMIZER COMPRISING SUCH A BELL CUP

(71) Applicant: Dürr Systems AG, Bietigheim-Bissingen (DE)

(72) Inventors: Herbert Martin, Weinstadt-Grossheppach (DE); Martin Stiegler, Beilstein (DE); Bernhard Seiz, Lauffen (DE); Thomas Buck, Sachsenheim (DE)

(21) Appl. No.: 18/702,138

(22) PCT Filed: Oct. 19, 2022
(86) PCT No.: PCT/EP2022/079094

§ 371 Date: Apr. 17, 2024

(30) Foreign Application Priority Data
Oct. 20, 2021 (DE) 10 2021 127 163.0

(51) Int. Cl. B05B 3/10; B05B 15/55

(52) U.S. Cl. CPC B05B 3/1014; B05B 15/55

(57) ABSTRACT

The disclosure relates to a bell cup for a rotary atomizer for spraying coating agent (e.g. paint), with a spray-off body with a ring-shaped spray-off edge for spraying the coating agent, a hub part for mounting the bell cup on a rotatable hollow shaft of the rotary atomizer, and a fastening arrangement for form-fittingly fastening of the bell cup on the hollow shaft of the rotary atomizer. The bell cup according to the disclosure additionally has an outer rinsing chamber for rinsing the outer circumferential surface of the bell cup with a rinsing agent and an outer rinsing channel for supplying the rinsing agent, the outer rinsing channel being supplied by a rinsing agent supply in the interior of the bell cup and flows into the outer rinsing chamber at its outlet opening.

### CROSS-REFERENCE TO RELATED APPLICATIONS

This application is a national stage of, and claims priority to, Patent Cooperation Treaty Application No. PCT/EP2022/079094, filed on Oct. 19, 2022, which application claims priority to German Application No. DE 10 2021 127 163.0, filed on Oct. 20, 2021, which applications are hereby incorporated herein by reference in their entireties.

### FIELD

The disclosure relates to a bell cup for a rotary atomizer for spraying coating agent (e.g. paint).

Furthermore, the disclosure relates to a rotary atomizer with such a bell cup.

### BACKGROUND

In modern painting installations for painting vehicle body components, rotary atomizers are usually used as application device, which use a turbine to rotate a bell cup that sprays off the paint from an annular spray-off edge. The bell cup is usually mounted on the turbine shaft of the rotary atomizer by means of a screw connection with a fine thread. However, this method of fastening the bell cup to the turbine shaft of the rotary atomizer has various disadvantages.

One disadvantage of the screw connection is that the fine thread can become contaminated, which requires relatively time-consuming cleaning of the fine thread, since contamination of the fine thread also causes imbalance of the bell cup, which in the worst case can lead to bearing failure.

Another disadvantage of the known fastening method is that numerous rotations of the bell cup relative to the turbine shaft are required to screw the bell cup onto the turbine shaft.

Furthermore, with this type of fastening by means of a screw connection, there is a risk that the bell cup can tilt relative to the turbine shaft, which can then lead to damage to the fine thread when it is screwed on.

Furthermore, in the event of jerky braking of the bell cup or blocking of the bearing unit in the turbine of the rotary atomizer, there is a risk of loosening of the screw connection due to the mechanical inertia of the bell cup.

Finally, with regard to the technical background of the disclosure, reference should also be made to WO 2011/009641 A1, US 2007/0090204 A1 and U.S. Pat. No. 6,341,734 B1.

With the known bell cups, there is also the problem that the outer circumferential surface of the bell cup becomes dirty during operation, as paint residue can adhere to the surface. This is particularly problematic when changing colors, as the paint residue of the old color (e.g. red paint) adhering to the outer circumferential surface of the bell cup can then contaminate the paint of the new color (e.g. blue paint), which leads to painting errors.

The disclosure is therefore based on the task of improving the known bell cups.

### BRIEF DESCRIPTION OF THE DRAWINGS

FIG. 1 shows a sectional view of a bell cup according to the disclosure mounted on a rotary atomizer.

FIG. 2 shows a detailed view from FIG. 1 with a clamping ball for clamping the bell cup on the hollow shaft of the rotary atomizer.

FIG. 3 shows a detailed view from FIG. 1 to explain the outer rinsing according to the disclosure, with the thick arrows showing the course of the rinsing agent flow.

FIGS. 4A-4C show different variants of the disclosure for the outer rinsing with different exit angles of the rinsing liquid into the outer rinsing chamber of the bell cup.

FIG. 5 shows a perspective view of a bell cup according to the disclosure with the fastening arrangement according to the disclosure.

FIG. 6 shows a cross-sectional view of the fastening arrangement according to the disclosure with three pairs of clamping balls.

FIG. 7 shows a detailed view from FIG. 1 with the centering cones of the bell cup on one side and the hollow shaft on the other.

FIGS. 8A-8D show various stages during an assembly operation.

FIGS. 9A-9D show various views of a further exemplary embodiment with a screw connection between the bell cup and the hollow shaft of the rotary atomizer.

FIG. 10 shows a cross-sectional view through a further exemplary embodiment according to the disclosure with an annular outer rinsing channel in a two-part bell cup.

FIG. 11 shows a modification of FIG. 10 with a one-piece bell cup.

### DETAILED DESCRIPTION

The bell cup according to the disclosure serves for mounting on a rotary atomizer for spraying coating agent (e.g. paint). It should be mentioned here that the disclosure is not limited to bell cups intended for the application of paint. Rather, the bell cup according to the disclosure can also be designed for the application of other coating agents. Thus, the disclosure is not limited to paint with respect to the coating agent to be applied. Furthermore, it should be mentioned that the term bell cup used in the context of the disclosure is to be understood in a general sense and also includes, for example, spraying discs of disc atomizers. Preferably, however, the bell cup according to the disclosure is a bell cup in the actual sense.

In accordance with the known bell cups, the bell cup according to the disclosure first of all has a spray-off body with an annular circumferential spray-off edge for spraying off the coating agent.

Furthermore, in accordance with known bell cups, the bell cup according to the disclosure has a hub part for mounting the bell cup on a rotatable hollow shaft of the rotary atomizer. It should be mentioned here that in the preferred embodiment of the disclosure, the hub part and the spray-off body are separate components which can be connected to each other, for example, by a screw connection. However, within the scope of the disclosure, it is alternatively also possible that the spray-off body and the hub part are one-piece and together form a unitary component.

Furthermore, the bell cup according to the disclosure also provides a fastening arrangement for fastening the bell cup to the hollow shaft of the rotary atomizer, for example, with a form-fit by a conventional screw connection or by a new type of form-fit clamping connection, which will be explained in detail later on.

The bell cup according to the disclosure is distinguished from the prior art by an outer rinsing in order to clean the bell cup from paint residues. Thus, in accordance with the known bell cups, the bell cup according to the disclosure has an outer circumferential surface which, for example, is conical and leads to the spray-off edge of the bell cup on the outside. This outer circumferential surface can become dirty during painting and must therefore be cleaned occasionally. For this purpose, the bell cup according to the disclosure preferably has an outer rinsing chamber, in accordance with the known bell cups, which is preferably located on the rear side of the bell cup. During a rinsing process, rinsing agent is then introduced into the outer rinsing chamber of the bell cup. The rinsing agent then flows automatically from the outer rinsing chamber onto the outer circumferential surface of the bell cup, which cleans the outer circumferential surface of the bell cup. The distribution of the rinsing agent on the outer circumferential surface of the bell cup can be promoted by shaping air, which is blown essentially axially onto the outer circumferential surface of the bell cup from behind.

In order to introduce the rinsing agent into the outer rinsing chamber, the bell cup according to the disclosure has an outer rinsing channel in accordance with the known bell cups, whereby the outer rinsing channel starts from a rinsing agent supply in the interior of the bell cup and opens into the outer rinsing chamber at its outlet opening. The mode of operation of the outer rinsing system described above is also described, for example, in EP 0 715 896 A2 and EP 2 464 459 B1.

It has already been mentioned above that the hub part on the one hand and the spay-off body on the other hand can be separate components that are connected to each other, for example by a screw connection, in particular with an internal thread on the hub part and an external thread on the spay-off body of the bell cup. This makes it possible for the outer rinsing channel to run between the hub part and the spay-off body over part of its length.

It should be mentioned here that the outer rinsing channel in the area between the hub part and the spay-off body is preferably an annular channel that runs in a ring around the entire circumference. This is also a difference to the prior art, in which several outer rinsing channels are provided distributed around the circumference, so that in the prior art no rinsing agent is dispensed onto the outer circumferential surface of the bell cup in the area between the outer rinsing channels. In the disclosure, on the other hand, the annular circumferential outer rinsing channel allows the rinsing agent, which is supplied via several (e.g. eight) rinsing channels, to accumulate. This offers the advantage that the rinsing agent is distributed over the entire circumference of the annular channel, so that a more even, more efficient outer rinsing is possible. It should be mentioned here that the idea of an annular circumferential outer rinsing channel is not only feasible with a bell cup, in which the spay-off body and the hub part are separate components. Rather, this idea can also be realized with a bell cup in which the spay-off body and the hub part form a one-piece component.

In the preferred embodiment of the disclosure, the outer rinsing chamber of the bell cup has an outer boundary wall that widens in the proximal direction, so that the rinsing agent introduced into the outer rinsing chamber flows along the outer boundary wall of the outer rinsing chamber in the proximal direction due to the centrifugal force acting on the rinsing agent. During a rinsing process, the rinsing agent therefore first passes through the outer rinsing channel into the outer rinsing chamber of the bell cup. There, the centrifugal force acting on the rinsing agent causes the rinsing agent to flow along the outer boundary wall of the outer rinsing chamber in a proximal direction towards the rear edge of the bell cup. From there, the rinsing agent then reaches the outer circumferential surface of the bell cup due to the centrifugal force and flows over the outer circumferential surface of the bell cup, whereby adhering paint residues are loosened. Additional blowing with shaping air from behind can prevent the rinsing agent from detaching from the outer circumferential surface of the bell cup and being spun off.

It has already been mentioned above that the outer rinsing channel opens with its outlet opening into the outer rinsing chamber of the bell cup in order to introduce the rinsing agent into the outer rinsing chamber. In the area between the hub part and the spay-off body, the outer rinsing channel can form a deflection that causes a change in direction of the rinsing agent flow in the outer rinsing channel. In this way, the flow of rinsing agent in the outer rinsing channel runs upstream in front of the outlet opening, preferably in a distal direction at an angle to the axis of rotation of the bell cup. Downstream after the deflection, the rinsing agent then enters the outer rinsing chamber preferably in a proximal direction, whereby different outlet angles relative to the axis of rotation of the bell cup are possible.

In one variant of the disclosure, the flow of rinsing agent enters the outer rinsing chamber from the outlet opening of the outer rinsing channel essentially parallel to the axis of rotation of the bell cup, whereby a tolerance range of ±10°, ±5° or ±2° is possible. The angle between the rinsing agent flow and the axis of rotation can, for example, be in the range from −10° to +10°, −5° to +5° or −2° to +2°.

In another variant of the disclosure, on the other hand, the flow of rinsing agent emerging from the outlet opening of the outer rinsing channel into the outer rinsing chamber is inclined outwards, for example with an outlet angle relative to the axis of rotation of the bell cup of +15°, whereby a tolerance range of ±10°, ±5° or ±2° is possible. The angle between the rinsing agent flow and the axis of rotation can, for example, be in the range of +5° to +25°, +10° to +20° or +13° to +17°.

In yet another variant of the disclosure, however, the flow of rinsing agent emerging from the outlet opening of the outer rinsing channel into the outer rinsing chamber is inclined inwards, in particular with an outlet angle to the axis of rotation of the bell cup of at least −15°, −20° or −25°, whereby a tolerance range of ±10°, ±5° or ±20 is possible. The purpose of this inward inclination is to detach and swirl the rinsing agent at the edge so that it reaches everywhere. The angle between the rinsing agent flow and the axis of rotation can, for example, be in the range from −25° to −5°, −20° to −10° or −17° to −13°. The purpose of this inward slope is to cause the rinsing agent to peel off the edge and swirl so that it goes everywhere.

In the context of the disclosure, the above-described aspect of the disclosure of outer rinsing has its own significance worthy of protection independently of the other aspects of the disclosure and in particular also independently of the fastening arrangement according to the disclosure.

According to another aspect of the disclosure, the bell cup according to the disclosure is now distinguished by the structural design and functionality of the fastening arrangement. Thus, in contrast to the prior art, it is preferably not a screw connection. Instead, in the case of the bell cup according to the disclosure, the fastening arrangement preferably has, in the outer lateral surface of the hub part, an annular circumferential clamping surface which is inclined with respect to the axis of rotation of the bell cup and, in the assembled state, forms an abutment surface for abutment of a clamping element (e.g. clamping ball) of the rotary atomizer in order to clamp the bell cup with an axial clamping force on the hollow shaft of the rotary atomizer. Thus, the fastening arrangement according to the disclosure does not feature a screw connection, but rather provides for a clamping connection. The connection between the bell cup on the one hand and the hollow shaft of the rotary atomizer on the other hand is thus preferably made without a screw connection within the scope of the disclosure. For the avoidance of misunderstandings, however, it is pointed out that the fastening arrangement according to the disclosure may have screw connections between the individual components of the fastening arrangement. However, these screw connections do not serve to establish the connection between the bell cup on the one hand and the hollow shaft of the rotary atomizer on the other hand.

The fastening arrangement according to the disclosure serves first of all to mechanically fasten the bell cup to the hollow shaft of the rotary atomizer. In addition, however, the fastening arrangement according to the disclosure can also fulfill another function, namely centering the bell cup on the hollow shaft of the rotary atomizer. For this purpose, the hub part of the bell cup can have a centering cone on the outside for contact with a complementary centering cone in the hollow shaft of the rotary atomizer. The hollow shaft of the rotary atomizer thus has a centering cone on the inside at its distal end, which widens in the distal direction. Correspondingly, the centering cone on the hub part of the bell cup has a centering cone on the outside which tapers in the proximal direction. The two centering cones of the hub part on the one hand and the hollow shaft of the rotary atomizer on the other hand are preferably aligned concentrically to the axis of rotation of the bell cup and have the same cone angle to enable a good centering effect.

When the bell cup is mounted on the hollow shaft of the rotary atomizer, the aforementioned clamping connection produces an axial clamping force with which the bell cup is pressed in the axial direction onto the hollow shaft of the rotary atomizer. This presses the conical surfaces of the two centering cones of the hub part on the one hand and the hollow shaft of the rotary atomizer on the other axially onto each other, which then results in a good centering effect. It is desirable to achieve as exact an axial position of the bell cup as possible in the assembled state. The hub part of the bell cup therefore preferably has a plane surface on the outside, which is intended to form an axial stop for the bell cup. The plane surface on the hub part therefore preferably runs annularly and concentrically around with respect to the axis of rotation of the bell cup and is preferably aligned at right angles to the axis of rotation of the bell cup. The plane surface on the hub part of the bell cup then lies against the end face of the hollow shaft of the rotary atomizer in the assembled state, thus forming an axial stop. The plane surface on the hub part of the bell cup preferably adjoins the centering cone in the axial direction along the axis of rotation, the plane surface preferably being located between the centering cone and the spray-off edge of the bell cup in the axial direction.

The aforementioned clamping connection between the bell cup on the one hand and the hollow shaft of the rotary atomizer on the other hand is preferably established by a clamping ring, which, however, is not part of the bell cup, but is located in the associated fastening arrangement in the hollow shaft of the rotary atomizer. This clamping ring is preferably screwed into the hollow shaft of the rotary atomizer. This means that a rotation of the clamping ring in the hollow shaft of the rotary atomizer also leads to a corresponding axial displacement of the clamping ring, which can be utilized to generate the necessary axial clamping forces. Rotation of the clamping ring to generate the required clamping forces is preferably performed by the bell cup during assembly of the bell cup. For this purpose, the hub part of the bell cup can have a receptacle for a driver, the driver projecting as a projection in the axial direction from the clamping ring in the hollow shaft of the rotary atomizer and, in the assembled state, projecting in the axial direction into the receptacle in the hub part of the bell cup, so that the bell cup also rotates the clamping ring during assembly. When mounting the bell cup on the rotary atomizer, the bell cup is first placed on the hollow shaft so that the driver on the clamping ring projects into the receptacle in the hub part of the bell cup. When the bell cup is subsequently rotated, the clamping ring is then rotated, resulting in a corresponding axial displacement of the clamping ring. The bell cup is then rotated until the centering cones on the hollow shaft of the rotary atomizer on the one hand and on the hub part on the other hand are in contact with each other and the plane surface on the hub part abuts against the end face of the hollow shaft.

However, the disclosure is not limited to the novel fastening arrangement described above with regard to the fastening of the bell cup to the hollow shaft of the rotary atomizer. Rather, within the scope of the disclosure, it is also possible for the bell cup to be attached to the hollow shaft of the rotary atomizer in a conventional manner, for example by means of a screw connection, as is known per se from the prior art.

It has already been mentioned at the outset that the spray-off body and the hub part can be in one piece and thus form a unitary component. In the preferred embodiment of the disclosure, however, it is provided that the spray-off body on the one hand and the hub part on the other hand are separate components which are mechanically connected to one another, for example by a screw connection of the hub part to the spray-off body, in particular with an internal thread on the hub part and an external thread on the spray-off body.

In addition to the bell cup according to the disclosure described above, the disclosure also claims protection for a correspondingly adapted rotary atomizer.

First of all, in accordance with the known rotary atomizers, the rotary atomizer according to the disclosure has a rotatably mounted hollow shaft for rotating the bell cup in operation, wherein the hollow shaft can be driven, for example, by a turbine, as is known per se from the prior art and therefore need not be described in more detail.

In accordance with the known rotary atomizers, the rotary atomizer according to the disclosure also has a fastening arrangement which makes it possible to fasten the bell cup to the hollow shaft of the rotary atomizer in a form-fitting manner.

In the known rotary atomizers, the fastening arrangement enables—as already mentioned—a screw connection between the bell cup on the one hand and the hollow shaft of the rotary atomizer on the other. In the rotary atomizer according to the disclosure, on the other hand, it is provided that the fastening arrangement in the hollow shaft of the rotary atomizer has at least one clamping element (e.g. clamping ball) which serves to bear against a corresponding clamping surface on the hub part of the bell cup in order to clamp the bell cup with an axial clamping force on the hollow shaft of the rotary atomizer.

In the preferred embodiment of the disclosure, the at least one clamping element is a clamping ball that has a range of motion in the radial direction in the hollow shaft of the rotary atomizer. In a radially inward clamping position, the clamping element then firmly clamps the bell cup on the hollow shaft of the rotary atomizer. In a radially outward release position, on the other hand, the clamping element releases the bell cup to allow assembly or disassembly of the bell cup.

Here, a cage (e.g. ball cage) is preferably provided for radially movable mounting of the clamping element in the hollow shaft of the rotary atomizer, the cage preferably being arranged with the clamping element (e.g. clamping ball) inside the hollow shaft of the rotary atomizer. For example, the cage can be screwed with its external thread into a corresponding internal thread of the hollow shaft of the rotary atomizer.

It has already been briefly mentioned above that the clamping element (e.g. clamping ball) can be moved radially between an outer release position and an internal clamping position. For the movement of the clamping element from the outwardly located release position to the inwardly located clamping position, a clamping ring can be provided, which can be arranged in the ring gap between the cage and the hollow shaft of the rotary atomizer. This clamping ring is preferably connected to the hollow shaft of the rotary atomizer by a screw connection, the screw connection having an external thread on the clamping ring and an internal thread in the hollow shaft of the rotary atomizer, so that a rotation of the clamping ring relative to the hollow shaft of the rotary atomizer leads to a corresponding axial displacement of the clamping ring in the hollow shaft of the rotary atomizer. At its proximal end, the clamping ring preferably has a clamping surface that is angled with respect to the axis of rotation of the bell cup and widens in the proximal direction, so that the clamping ring presses the clamping element radially inward into the clamping position when moving in the proximal direction. During a fastening process, the clamping ring is thus rotated in the hollow shaft, which leads to a corresponding axial displacement of the clamping ring, so that the clamping ring then finally presses the at least one clamping element (e.g. clamping ball) from the outwardly located release position into the inwardly located clamping position.

It should be mentioned here that during the actual painting operation, centrifugal forces act on the clamping element due to the high speed of the hollow shaft of the rotary atomizer, which press the clamping element radially outward. Due to these centrifugal forces, the clamping element (e.g. clamping ball) presses against the clamping surface of the clamping ring during operation, which leads to axial tension between the clamping ring on the one hand and the hollow shaft of the rotary atomizer on the other, so that the frictional forces in the screw connection between the clamping ring and the hollow shaft increase with the speed. This counteracts loosening of the screw connection during painting.

It has already been mentioned above that the clamping ring is rotated during the fastening process, which then leads to a corresponding axial displacement of the clamping ring in the hollow shaft of the rotary atomizer. This rotation of the clamping ring is preferably caused by the bell cup, which is first placed on and then rotated relative to the turbine shaft during a fastening process. This rotation of the clamping ring by the bell cup is made possible by the fact that a driver projects from the clamping ring in the axial distal direction and engages in a corresponding receptacle in the hub part of the bell cup, so that the bell cup also rotates the clamping ring when it is rotated during assembly or disassembly.

In the assembled state, a certain axial clamping force acts on the rotatable clamping ring, whereby this axial clamping force is converted into a corresponding surface-normal clamping force due to the inclination of the clamping surface of the clamping ring, which acts on the clamping element (e.g. clamping ball). The clamping surface of the clamping ring is angled to the axis of rotation of the bell cup in such a way that a certain force transmission ratio is established between the axial clamping force on the clamping ring on the one hand and the surface-normal clamping force on the clamping element on the other. This force transmission ratio is preferably at most 1:8 and is preferably greater than 1:1, 1:2, 1:4 or 1:6. The surface-normal clamping force on the clamping element is therefore preferably substantially greater than the axial clamping force on the clamping ring.

In addition, it should be mentioned that a certain frictional force occurs in the screw connection between the clamping ring on the one hand and the hollow shaft of the rotary atomizer on the other, which depends on the axial clamping force on the clamping ring. The ratio between the frictional force of the screw connection on the one hand and the axial clamping force on the clamping ring on the other hand is preferably at least 0.5:1, 1:1 or 1:2 and is preferably at most 1:6.

In the preferred embodiment of the disclosure, the cage (e.g. ball cage) preferably contains several pairs of clamping elements (e.g. clamping balls), wherein the pairs of clamping elements may be distributed over the circumference. In the preferred embodiment of the disclosure, the pairs of clamping elements are evenly distributed over the circumference, wherein, for example, three pairs may be provided. The distance between the clamping elements within a pair of clamping elements is here preferably smaller than the distance between the clamping elements of adjacent pairs.

Furthermore, it should be mentioned that the at least one clamping element (e.g. clamping ball) can be made of steel, ceramics, plastic or glass, for example, to name just a few examples of materials.

It should be mentioned here that the at least one clamping element (e.g. clamping ball) rests against a counterpart during operation, this being the clamping surface, which is preferably formed on the hub part of the bell cup. Here it is advantageous if the at least one clamping element (e.g. clamping ball) on the one hand and the clamping surface on the other hand consist of different materials, since such a material pairing has proven to be advantageous. For example, the at least one clamping element (e.g. clamping ball) can be made of ceramic, while the clamping surface or hub part is made of steel, in particular hardened steel. However, it is also possible within the scope of the disclosure that other material pairings of materials are used which have different material properties, in particular with respect to their hardness.

The individual clamping elements (e.g. clamping balls) preferably have a diameter that is in the range of 1 mm-5 mm.

Furthermore, it should be mentioned that the number of clamping elements can be, for example, 3, 4, 5, 6, 7, 8, 9, 10, 11 or 12.

Furthermore, it should also be mentioned that the clamping connection between the angled clamping surface of the clamping ring on the one hand and the clamping element (e.g. clamping ball) on the other hand is preferably self-locking.

It should also be mentioned that the clamping ring can have an undulating section in longitudinal section in order to make the clamping ring elastically flexible in the axial direction.

It has already been mentioned above that the actual connection between the rotary atomizer on the one hand and the bell cup on the other is not made by a screw connection, but by a new type of clamping connection. However, even in the fastening system according to the disclosure, the fastening arrangements in the rotary atomizer and in the bell cup preferably contain screw connections. Here, there is a risk that such screw connections may become loose during operation. For example, a blockage of the hollow shaft of the rotary atomizer leads to a jerky braking of the hollow shaft, as a result of which the threaded connections are also subjected to a corresponding torque. In this case, it is advantageous if the torque occurring during such a blockage does not lead to loosening of the threaded connections, but to tightening of the threaded connections. This is advantageous because then, in the event of a blockage of the hollow shaft of the rotary atomizer, there is no risk of the bell cup becoming detached from the rotary atomizer. The threaded connections are therefore preferably right-hand threads, while the rotary atomizer is preferably designed to rotate the hollow shaft to the left in painting operation, i.e., counterclockwise when viewed axially in the distal direction. Braking or even blocking of the hollow shaft of the rotary atomizer then causes the threaded connections to be tightened.

In the preferred embodiment of the disclosure, the hub part of the bell cup has, at least in sections, a cylindrical outer surface, the cylindrical outer surface of the hub part preferably forming an inner boundary wall of the outer rinsing chamber of the bell cup.

The hollow shaft of the rotary atomizer preferably also has a cylindrical outer surface at least in sections, in particular at the distal end of the hollow shaft, the cylindrical outer surface of the hollow shaft of the rotary atomizer preferably forming an inner boundary wall of the outer rinsing chamber of the bell cup.

It should be mentioned here that the cylindrical outer surface of the hollow shaft in the preferred embodiment of the disclosure merges into the cylindrical outer surface of the hub part essentially without a step.

### BRIEF DESCRIPTION OF THE DRAWINGS

The drawings show a bell cup 1 which is partially of conventional construction and rotates in operation about an axis of rotation 2, as will be described in detail. In conventional manner, the bell cup 1 comprises a spray-off body 3 with an annular circumferential spray-off edge 4 for spraying the paint to be applied.

A distributor disc holder 5 is arranged centrally in the spray-off body 3 on its end face, a distributor disc 6 being fastened to the distributor disc holder 5. The distributor disk 6 has the task of distributing paint supplied centrally and axially radially outwardly on an overflow surface 7, so that the paint then passes along the overflow surface 7 outwardly to the annularly circumferential spray-off edge 4 and is sprayed off there.

Furthermore, the spray-off body 3 of the bell cup 1 comprises an outer circumferential surface 8 which is conically shaped and widens in the distal direction, the circumferential surface 8 leading to the spray-off edge 4. In painting operation, this outer circumferential surface 8 becomes soiled by paint residues, which occasionally makes it necessary to clean the outer circumferential surface 8 of the bell cup 1. For this purpose, the spray-off body 3 comprises an outer rinsing chamber 9 on its rear side, into which rinsing agent is introduced during a cleaning operation, as will be described in detail. Due to the centrifugal forces, the rinsing agent then automatically passes from the outer rinsing chamber 9 to the outside onto the outer circumferential surface 8 of the bell cup 1, whereby the distribution of the rinsing agent on the outer circumferential surface 8 can be supported by shaping air, which is blown from behind in the axial direction against the outer circumferential surface 8.

Furthermore, the drawings show a rotary atomizer 10 with a hollow shaft 11 which is rotated by a compressed air turbine, as is known per se from the prior art, so that the compressed air turbine is not shown for simplification.

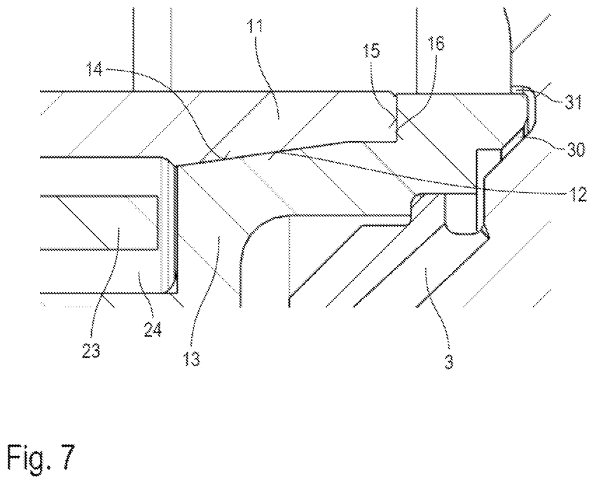

At its distal end, the hollow shaft 11 has a centering cone 12 on the inside, as can be seen in particular in FIG. 7. The centering cone 12 serves for exact centering of the bell cup 1 on the hollow shaft 11 of the rotary atomizer 10, as will be described in detail.

The bell cup 1 further has a hub part 13, which is firmly screwed to the spray-off body 3 of the bell cup 1.

The hub part 13 also has a centering cone 14 on the outside, as can be seen in particular in FIG. 7. The centering cones 12, 14 of the hollow shaft 11 of the rotary atomizer 10 on the one hand and of the hub part 13 of the bell cup 1 on the other hand have the same cone angle and lie against each other in the assembled state, as can be seen well in particular from FIG. 7, whereby the bell cup 1 is centered on the hollow shaft 11 of the rotary atomizer 10.

In addition, the hub part 13 of the bell cup 1 has an annular circumferential plane surface 15, which is aligned at right angles to the axis of rotation 2 of the bell cup 1, as can be seen in particular in FIG. 7. The plane surface 15 forms an axial stop for the bell cup 1 and, in the assembled state, rests against an end face 16 of the hollow shaft 11 of the rotary atomizer 10, as can be seen clearly in FIG. 7. In the assembled state of the bell cup 1, the centering cones 12, 14, which rest against one another, effect centering, while the plane surface 15 forms an axial stop for the bell cup 1 with the end face 16.

A ball cage 17 is screwed into the hollow shaft 11 of the rotary atomizer 10, the ball cage 17 holding a plurality of clamping balls 18 in a radially movable and loss-proof manner. The clamping balls 18 have a radial range of movement between an outer release position and an inner clamping position, as will be described in detail.

In the annular gap between the ball cage 17 and the hollow shaft 11 of the rotary atomizer 10 there is a clamping ring 19, which is screwed into the hollow shaft 11 of the rotary atomizer 10 by a screw connection 20. A rotation of the clamping ring 19 in the hollow shaft 11 also leads to a corresponding axial displacement of the clamping ring 19 within the hollow shaft 11, which is used in a fastening process, as will be described in detail.

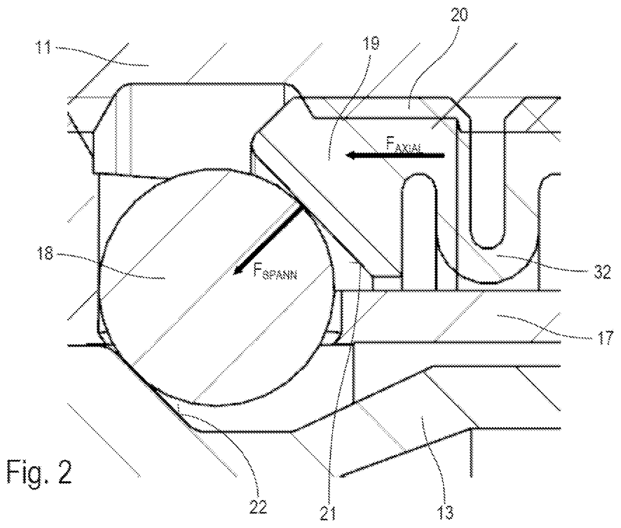

At its proximal end, the clamping ring 19 has a clamping surface 21 which is inclined to the rotational axis 2 of the bell cup 1, as shown in particular in FIG. 2. During a fastening operation, the clamping surface 21 presses on the clamping ball 18 and can push it from the radially outward release position to the radially inward clamping position.

The hub part 13 of the bell cup 1 has a corresponding clamping surface 22 at its proximal end. If the clamping ring 19 now presses the clamping ball 18 with its clamping surface 21 from the radially outer release position into the radially inner clamping position, the clamping ball 18 presses against the clamping surface 22 on the hub part 13, whereby the bell cup 1 is clamped axially on the hollow shaft 11 of the rotary atomizer 10.

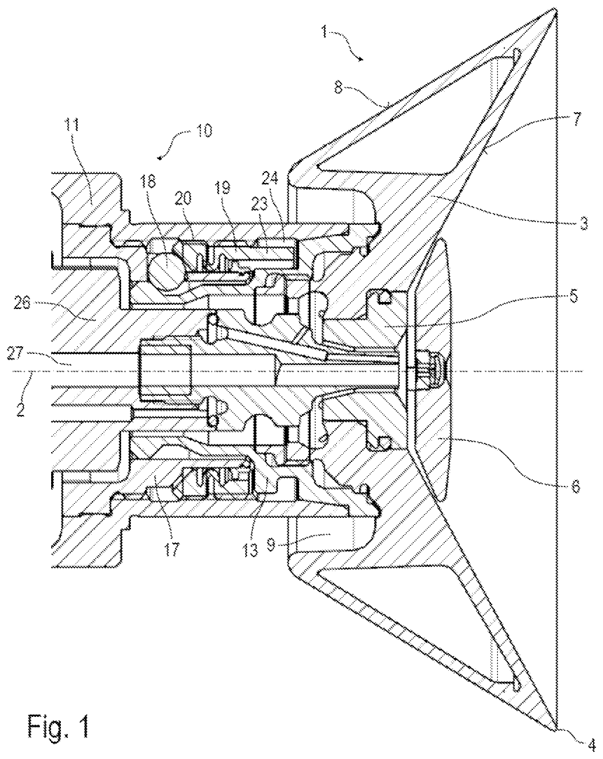

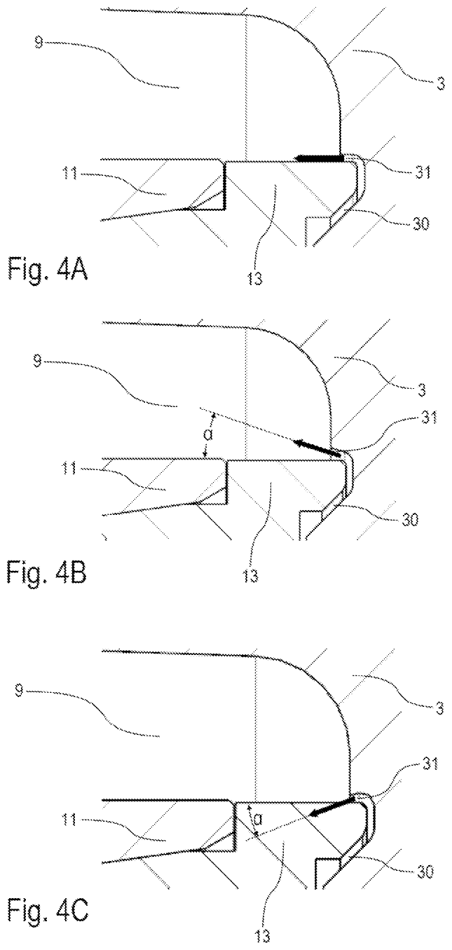

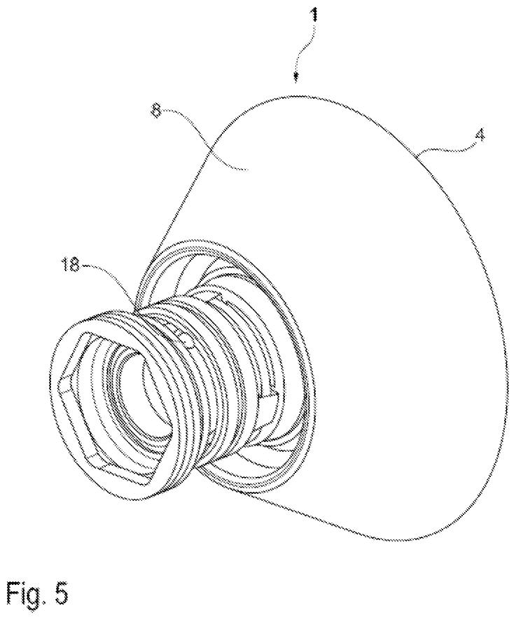

Furthermore, it can be seen from FIG. 1 and FIG. 4A that the hollow shaft 11 of the rotary atomizer 10 projects in the axial direction into the outer rinsing chamber 9 of the bell cup 1. This enables a short axial distance a between the front end of the hollow shaft 11 on the one hand and the center of mass of the bell cup 1 on the other, which is advantageous for low-vibration concentricity.

FIG. 2 shows that the clamping ring 19 presses against the clamping ball 18 with a certain axial clamping force F_{AXIAL}. Due to the inclination of the clamping surface 21 of the clamping ring 19 relative to the axis of rotation 2 of the bell cup 1, a normal clamping force F_{SPANN} acts on the clamping ball 18. The inclination of the clamping surface 21 thus causes a force conversion between the axial clamping force F_{AXIAL} and the normal clamping force F_{SPANN}. The force conversion can have a force transmission ratio of, for example, 1:4, i.e. the normal clamping force F_{SPANN} is four times as large as the axial clamping force F_{AXIAL}.

It has already been mentioned above that a rotation of the clamping ring 19 relative to the hollow shaft 11 of the rotary atomizer 10 due to the screw connection 20 leads to a corresponding axial displacement of the clamping ring 19, whereby the bell cup 1 is axially clamped on the hollow shaft 11. The rotation of the clamping ring 19 required for this is effected by the bell cup 1. For this purpose, the bell cup 1 is inserted with its hub part 13 into the hollow shaft 11. Drivers 23 on the clamping ring 19 then project into corresponding receptacles 24 in the hub part 13 of the bell cup 1. When the bell cup 1 is rotated, the drivers 23 are then taken along by the receptacles 24 and also rotated, which then leads to the rotation of the clamping ring 19.

After the bell cup 1 has been placed on the rotary atomizer 10, the rotation of the bell cup 1 thus leads to a corresponding rotation of the clamping ring 19, which is also axially displaced in the process. The axial displacement of the clamping ring 19 then causes the clamping balls 18 to press radially inwards against the clamping surface 22 at the proximal end of the hub part 13, as a result of which the hub part 13 is clamped axially in the hollow shaft 11.

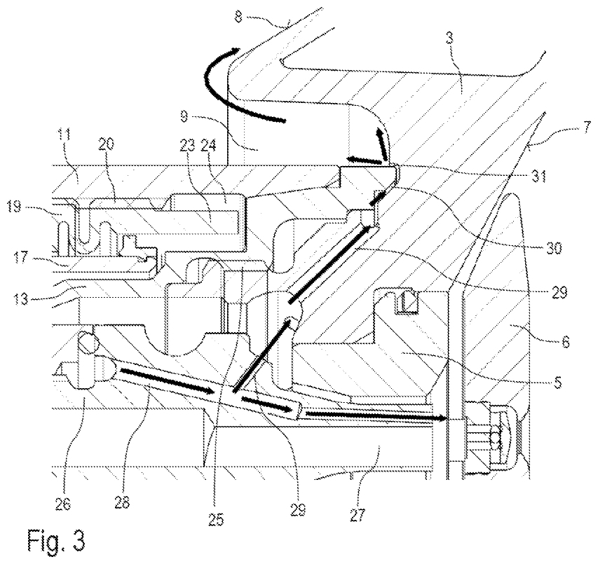

Furthermore, it should also be mentioned that the hub part 13 on the one hand and the spray-off body 3 of the bell cup 1 on the other hand are separate components which are connected to each other by a screw connection 25, as can be seen for example in FIG. 3. This advantageously enables the outer rinsing of the outer circumferential surface 8 of the bell cup 1. Thus, a paint nozzle 26 runs in the hollow shaft 11 of the rotary atomizer 10, which has two tasks, as is also described in principle in EP 2 464 459 B1.

On the one hand, the paint nozzle 26 feeds the paint to be applied via a central paint channel 27, which then impinges axially on the distributor disk 7 and is deflected outward.

Secondly, the paint nozzle contains an outer rinsing channel 28, as can be seen in particular in FIG. 3. The outer rinsing channel 28 also directs the rinsing agent forwards to the distributor disk 6. In addition, a further outer rinsing channel 29 branches off from the outer rinsing channel 28 and directs part of the rinsing agent outwards into the outer rinsing chamber 9. On a section 30, the outer rinsing channel 29 runs between the hub part 13 and the spray-off body 3, where it forms an annular channel. With its outlet opening 31, the outer rinsing channel 29 then opens into the outer rinsing chamber 9.

In the area of the outlet opening 31, the outer rinsing channel 29 forms a deflection for the rinsing agent flow, as can be seen in various variants in FIGS. 4A-4C. Thus, the rinsing agent emerges from the outlet opening 31 with an outlet angle α relative to the axis of rotation 2.

In the disclosure variant according to FIG. 4A, the outlet angle α=0, i.e. the rinsing agent exits the outlet opening 31 in the proximal direction parallel to the axis of rotation 2.

In the variant of the disclosure according to FIG. 4B, on the other hand, the rinsing agent flow is inclined outwards at an angle of approximately α=15°.

In the variant according to FIG. 4C, on the other hand, the rinsing agent flow at the outlet opening 31 is inclined inwardly at an angle of approximately α=15°. The purpose of this inward inclination is that the rinsing agent detaches and swirls at the edge so that it reaches everywhere.

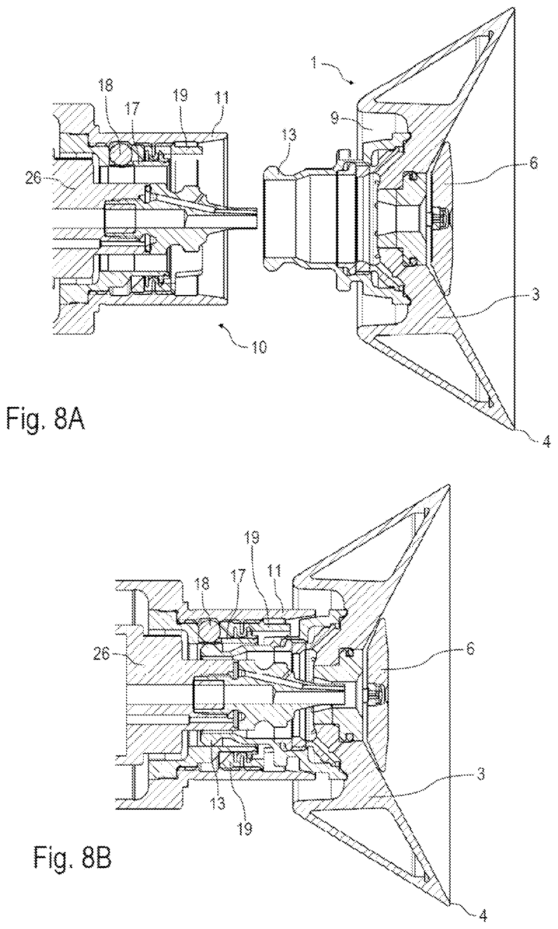

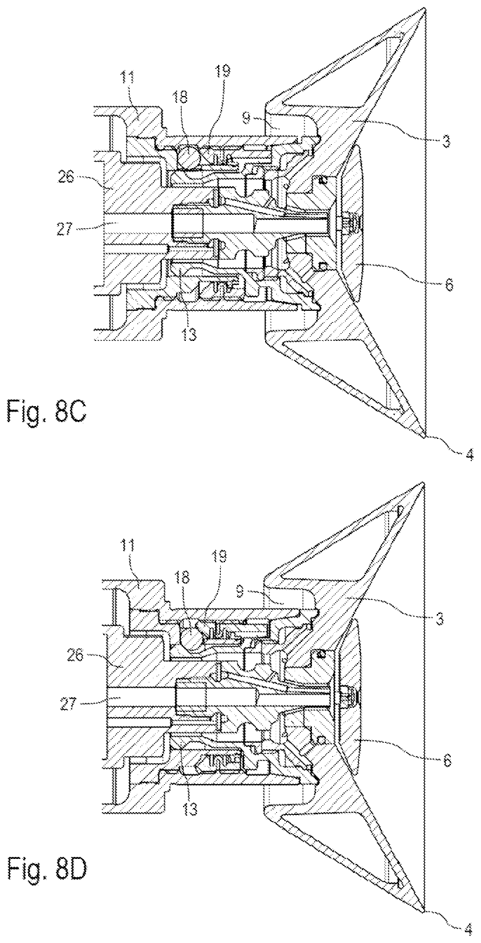

FIGS. 8A-8C show different stages in the assembly of the bell cup 1 on the hollow shaft 11 of the rotary atomizer 10.

In the assembly stage according to FIG. 8A, the bell cup 1 is still completely separated from the rotary atomizer 10.

In the assembly state according to FIG. 8B, however, the bell cup 1 with the hub part 13 is already inserted into the hollow shaft 11 of the rotary atomizer 10. The clamping ball 18 is still in its radially outward release position.

In the assembly stage shown in FIG. 8C, the bell cup 1 has already been placed further in the axial direction on the hollow shaft 11 of the rotary atomizer 10. However, the bell cup 1 is not yet at its axial stop, which is formed by the plane surface 15 on the hub part 13 on the one hand and the end face 16 of the hollow shaft 11 on the other.

FIG. 8D shows the final assembly stage. Here, the plane surface 15 on the lower part 13 of the bell cup 1 is in contact with the end surface 16 of the hollow shaft 11 of the rotary atomizer 10 and thus forms an axial stop.

In addition, the conical surfaces of the centering cones 12, 14 lie on each other and cause the bell cup 1 to be precisely centered on the hollow shaft 11 of the rotary atomizer 10.

Furthermore, the clamping ring 19 is rotated in the screw connection 20 to such an extent that it is displaced axially to such an extent that it presses the clamping ball 18 radially inwards into the clamping position with its clamping surface 21. In this clamping position, the clamping ball 18 presses against the clamping surface 22 at the proximal end of the hub part 13, thereby axially clamping the hub part 13 and thus also the entire bell cup 1 in the hollow shaft 11.

In addition, it should also be mentioned that the clamping ring 19 has an undulating section 32 (cf. FIG. 2) which allows elastic compliance of the clamping ring 19 in the axial direction.

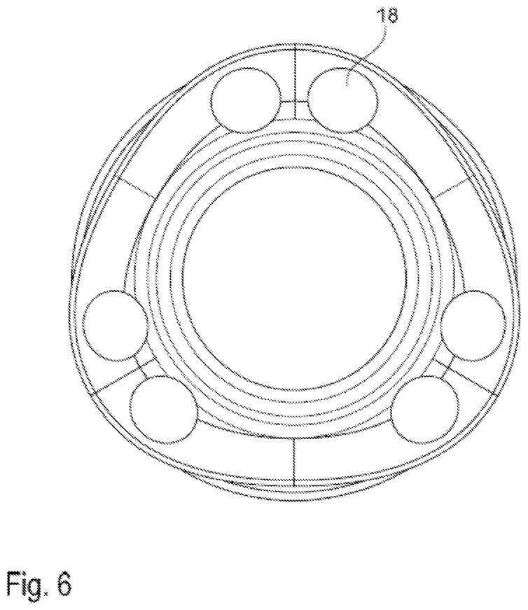

Further, FIG. 6 also shows that three pairs of clamping balls 18 are arranged distributed around the circumference.

FIG. 4A in particular shows that the hollow shaft 11 of the rotary atomizer 10 has a cylindrical outer surface 33 at its end, which merges seamlessly into a likewise cylindrical outer surface 34 of the hub part 13 of the bell cup 1.

Regarding the drawings described above, it should be mentioned that within the scope of the disclosure a modification is also possible in which the bell cup 1 is attached to the hollow shaft 11 of the rotary atomizer 10 not by a clamping connection, but by a conventional screw connection.

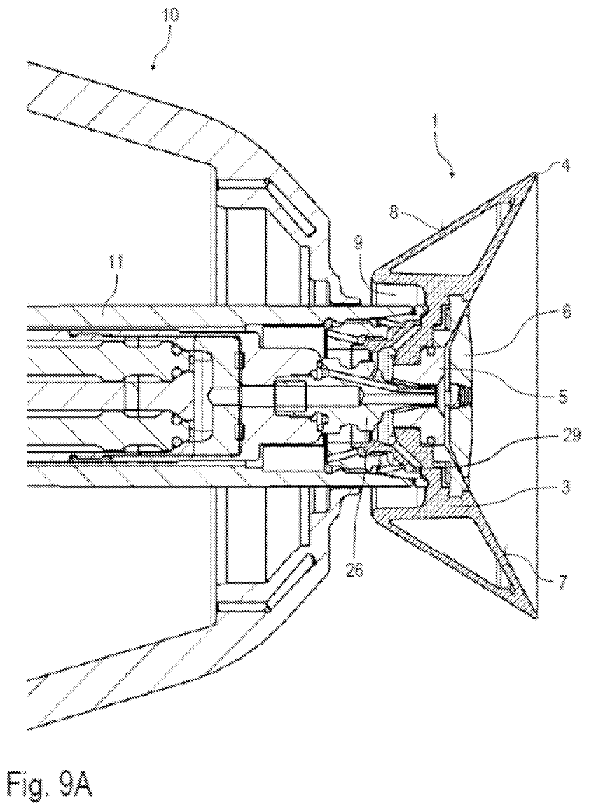

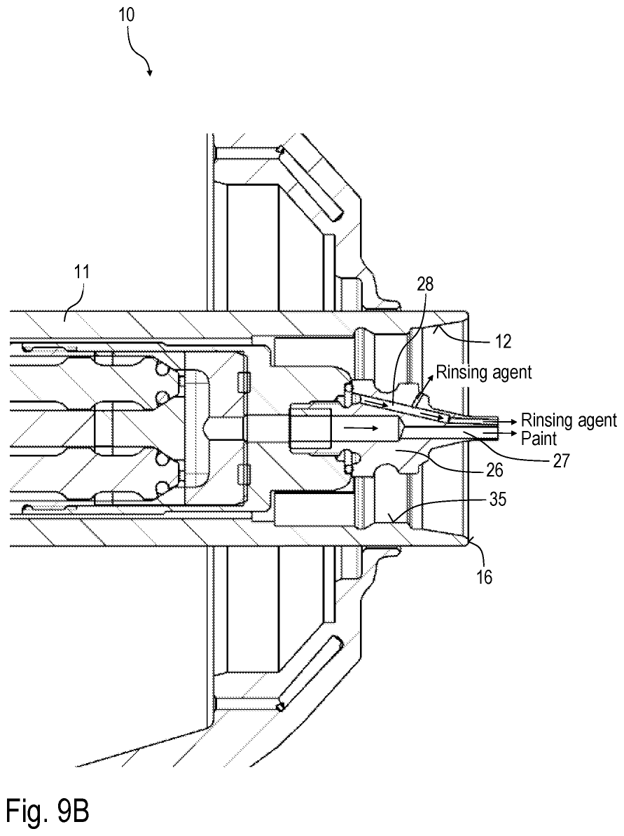

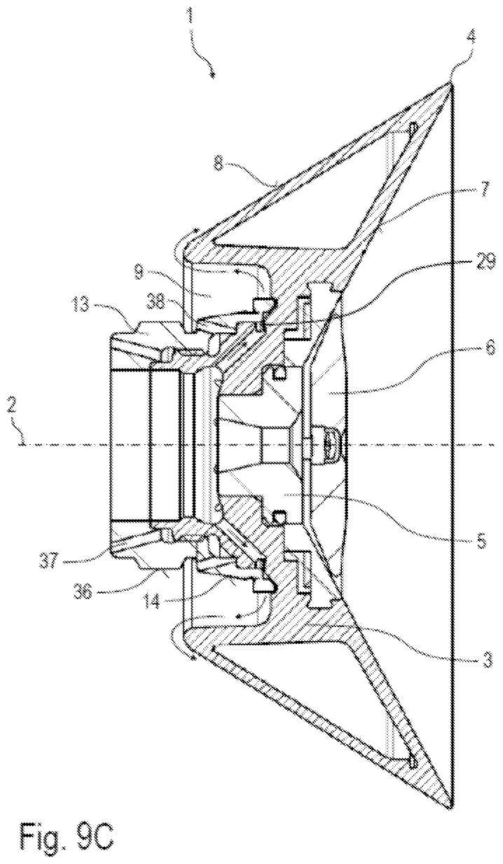

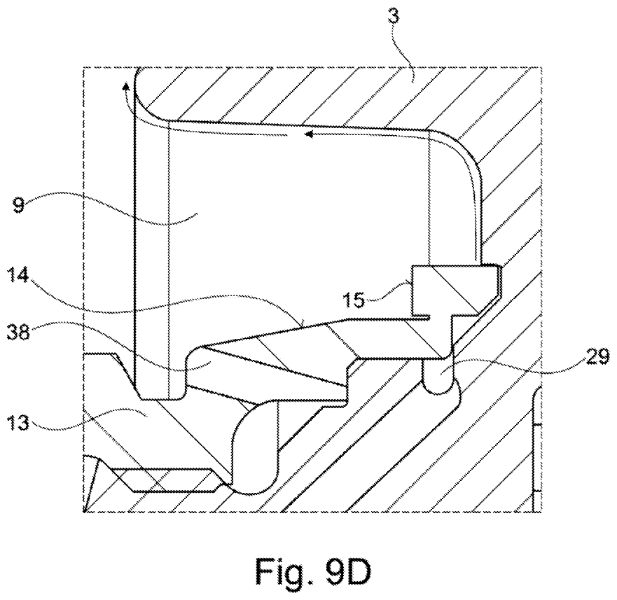

FIGS. 9A-9C show various views of an alternative exemplary embodiment according to the disclosure, which largely corresponds to the exemplary embodiment described above, so that to avoid repetition, reference is made to the above description, with the same reference numbers being used for corresponding details.

A feature of this exemplary embodiment is that the mechanical fastening of the bell cup 1 to the hollow shaft 11 of the rotary atomizer 10 is not carried out by a clamping connection, but rather by a conventional screw connection. For this purpose, the hollow shaft 11 of the rotary atomizer 10 has an internal thread 35 at its free end, which engages in a correspondingly adapted external thread 36 on the hub part 13 of the bell cup 1.

In FIGS. 9B and 9C, the flow path of the rinsing agent from the outer rinsing channel 28 of the paint nozzle 26 into the outer rinsing chamber 9 and finally onto the outer circumferential surface 8 of the bell cup 1 is shown by arrows. A rinsing groove runs between the hub part 13 of the bell cup 1 and the spay-off body 3 of the bell cup 1, through which the rinsing agent can flow outwards into the outer rinsing chamber 9.

In this exemplary embodiment, the spay-off body 3 and the hub part 13 of the bell cup 1 are separate components that are screwed together, as is also the case in the previously described exemplary embodiment. However, within the scope of the disclosure there is also the possibility that the hub part 13 and the spay-off body 3 of the bell cup 1 are in one piece and form a unitary component, which can consist, for example, of titanium or a titanium alloy.

With such a one-piece design of the hub part 13 with the spay-off body 3, the rinsing agent passage from the outer rinsing channel 29 of the bell cup 1 into the outer rinsing chamber 9 of the bell cup 1 requires a special design. For this purpose, a separate ring can be provided, which is arranged in the axial direction between the end face 16 of the hollow shaft 11 and the spay-off body 3 and surrounds the hub part 13 in a ring. A rinsing groove can then be arranged in this separate ring, through which the rinsing agent can flow from the outer rinsing channel 29 of the bell cup 1 into the outer rinsing chamber 9 of the bell cup 1.

Finally, the hub part 13 of the bell cup 1 in this exemplary embodiment has oblique channels 37, 38. The channels 37, 38 enable additional attachment of the spay-off body 3 to the hub part 13 of the bell cup 1. For this purpose, for example, adhesive can be filled into the channels 37, 38 from behind, the adhesive then forming an adhesive connection between the hub part 13 and the spay-off body 3 of the bell cup 1. Alternatively, there is the possibility that a laser welding process is carried out through the channels 37, 38 in order to weld the hub part 13 to the spay-off body 3 of the bell cup 1.

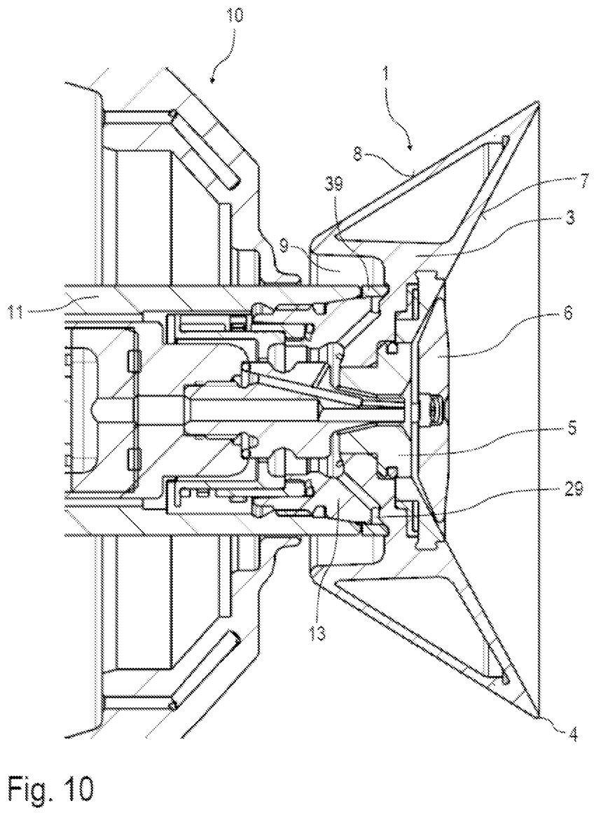

FIG. 10 shows a further exemplary embodiment of a rotary atomizer according to the disclosure, this exemplary embodiment largely corresponding to the exemplary embodiments described above, so that to avoid repetition, reference is made to the above description, the same reference numbers being used for corresponding details.

In this exemplary embodiment, too, an annular outer rinsing channel 29 is provided, which is arranged between the hub part 13 and the spay-off body 3 of the bell cup 1, the bell cup 1 being formed in one piece. This means that the spay-off body 3 and the hub part 13 are not separate components, but together form the bell cup 1.

To redirect the flow of rinsing agent from the annular outer rinsing channel 29 into the outer rinsing chamber 9, a separate ring 39 is provided, which surrounds the annular rinsing channel 29 in a ring on its outside. The ring 29 forms an annular gap at its distal end to the spay-off body 3, so that the rinsing agent can flow from the annular outer rinsing channel 29 through the annular gap between the ring 39 and the spay-off body 3 into the outer rinsing chamber 9.

What is shown here is the fact that the rinsing agent flows evenly over the entire circumference from the annular outer rinsing channel 29 into the outer rinsing chamber 9 and from there onto the outer circumferential surface 8 of the bell cup 1.

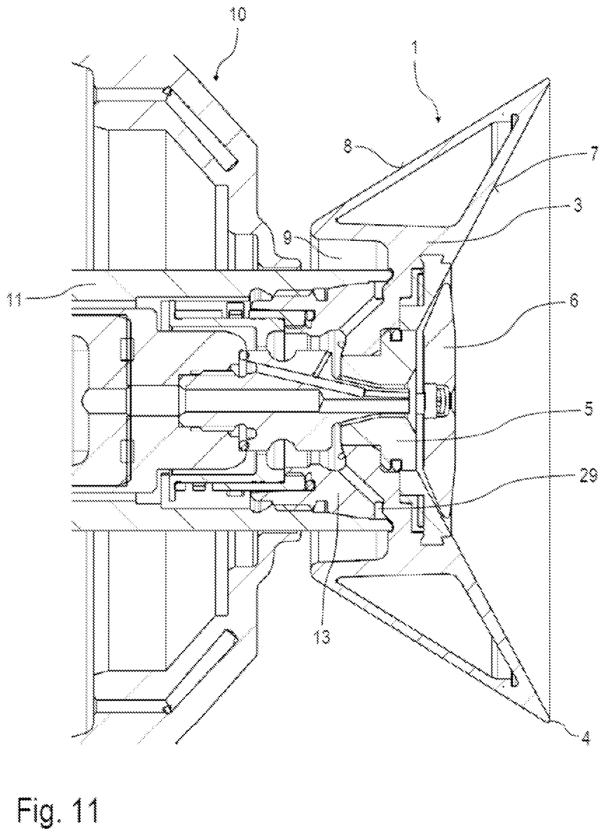

FIG. 11 shows a modification of the exemplary embodiment according to FIG. 10, so that in order to avoid repetitions, reference is made again to the above description, the same reference numbers being used for corresponding details.

Here too, the hub part 13 and the spay-off body 3 of the bell cup 1 are not designed as separate components. Rather, the bell cup 1 consists in one piece of the spay-off body 3 and the hub part 13.

In this exemplary embodiment, however, the ring 39 for redirecting the flow of rinsing agent from the annular outer rinsing channel 29 into the outer rinsing chamber 9 is omitted. Instead, the function of the ring 39 according to FIG. 10 is fulfilled in the exemplary embodiment according to FIG. 11 by the correspondingly shaped distal end of the hollow shaft 11 of the rotary atomizer 10. Otherwise, the functionality of the exemplary embodiment according to FIG. 11 is the same as in the exemplary embodiment according to FIG. 10. This means that between the distal end of the hollow shaft 11 of the rotary atomizer 10 and the spay-off body 3 there is an annular gap through which the rinsing agent is released from the annular outer rinsing channel 29 can flow into the outer rinsing chamber 9.

The disclosure is not limited to the preferred embodiments described above. Rather, the disclosure also includes variations and further embodiments which also make use of the inventive concept and therefore fall within the scope of protection. In particular, the disclosure also claims protection for the subject matter and the features of the dependent claims independently of the claims referenced in each case and in particular also without the features of the main claim. Thus, the disclosure comprises several aspects of the disclosure which enjoy protection independently of each other. These aspects of the disclosure include the outer rinsing described above, the bell cup fastening, the centering and the axial stop, to name but a few examples.

1.-23. (canceled)

24. A bell cup for a rotary atomizer for spraying coating agent, comprising:
a) a spray-off body with an annular circumferential spray-off edge for spraying off the coating agent,
b) an outer circumferential surface leading to the spray-off edge of the bell cup,
c) a hub part for mounting the bell cup on a rotatable hollow shaft of the rotary atomizer, and
d) a fastening arrangement for fastening of the bell cup to the hollow shaft of the rotary atomizer,
e) an outer rinsing chamber for rinsing the outer circumferential surface of the bell cup with a rinsing agent, and
f) at least one outer rinsing channel for supplying the rinsing agent, the outer rinsing channel starting from a rinsing agent supply in the interior of the bell cup and opening into the outer rinsing chamber at its outlet opening.

25. The bell cup according to claim 24, wherein that the fastening arrangement has, in the outer lateral surface of the hub part, an annularly circumferential clamping surface which is inclined with respect to the axis of rotation of the bell cup and is intended for bearing against a clamping element of the rotary atomizer, in order to clamp the bell cup firmly on the hollow shaft of the rotary atomizer with an axial clamping force.

26. The bell cup according to claim 25, wherein
a) the hub part of the bell cup comprises a centering cone on the outside for bearing against a complementarily shaped centering cone in the hollow shaft of the rotary atomizer,
b) the centering cone on the bell cup tapers in the proximal direction,
c) the centering cone on the bell cup runs concentrically to the axis of rotation of the bell cup.

27. The bell cup according to claim 26, wherein
a) the hub part of the bell cup comprises a plane surface on the outside for bearing against the end face of the hollow shaft of the rotary atomizer, so that the plane surface forms an axial stop,
b) the plane surface is ring-shaped circumferential with respect to the axis of rotation of the bell cup,
c) the plane surface runs concentrically to the axis of rotation of the bell cup,
d) the plane surface is aligned essentially at right angles to the axis of rotation of the bell cup,
e) the plane surface adjoins the centering cone in the axial direction,
f) the plane surface is located in the axial direction between the centering cone and the spray-off edge.

28. The bell cup according to claim 24, wherein the hub part of the bell cup has a receptacle for a driver, wherein the driver projects as a projection in the axial direction from a clamping ring in the hollow shaft of the rotary atomizer and, in the assembled state, projects in the axial direction into the receptacle in the hub part of the bell cup, so that the bell cup co-rotates the clamping ring during a rotation during assembly.

29. The bell cup according to claim 24, wherein
a) the outer circumferential surface is widening in the spray-off direction, and
b) the outer rinsing chamber is located on the rear side of the bell cup, and
c) the hub part and the spray-off body are separate components which are connected to one another.

30. The bell cup according to claim 29, wherein the hub part has at least one channel which runs from back to front to the spay-off body in order to mechanically connect the hub part to the spay-off body by an adhesive connection or through laser beam welding.

31. The bell cup according to claim 29, wherein
a) the outer rinsing channel runs over a section of its length between the hub part and the spray-off body, and
b) the outer rinsing channel in the section between the hub part and the spray-off body is an annular channel or opens into an annular channel which runs annularly around the entire circumference and dispenses the rinsing agent over the entire circumference, and
c) the hub part of the bell cup has a cylindrical outer surface which forms an inner boundary wall of the outer rinsing chamber, and
d) the outer rinsing chamber of the bell cup has an outer boundary wall which widens in the proximal direction, so that the rinsing agent introduced into the outer rinsing chamber flows along the outer due to the centrifugal force acting on the rinsing agent Boundary wall of the outer rinsing chamber flows in the proximal direction, and
e) the fastening arrangement is designed such that the hollow shaft of the rotary atomizer in the assembled state projects in the axial direction into the outer rinsing chamber of the bell cup.

32. The bell cup according to claim 24, wherein the fastening arrangement is designed such that the center of mass of the bell cup has an axial distance from the front end of the hollow shaft of the rotary atomizer that is less than 5 cm.

33. The bell cup according to claim 29, wherein
a) the outer rinsing channel forms a deflection in the section between the hub part and the spray-off body with a change in direction of the rinsing agent flow in the outer rinsing channel,
b) the rinsing agent in the outer rinsing channel upstream of the outlet opening of the outer rinsing channel flows in a distal direction, and
c) the rinsing agent is discharged from the outlet opening of the outer rinsing channel in proximal direction into the outer rinsing chamber.

34. The bell cup according to claim 33, wherein the rinsing agent flow emerging from the outlet opening of the outer rinsing channel into the outer rinsing chamber is aligned essentially parallel to the axis of rotation of the bell cup.

35. The bell cup according to claim 33, wherein the rinsing agent flow emerging from the outlet opening of the outer rinsing channel into the outer rinsing chamber is inclined outwardly.

36. The bell cup according to claim 33, wherein the rinsing agent flow emerging from the outlet opening of the outer rinsing channel into the outer rinsing chamber is inclined inwards.

37. The bell cup according to claim 24, wherein the spray-off body and the hub part are in one piece and together form a uniform component.

38. The bell cup according to claim 24, wherein the spray-off body and the hub part are separate components which are connected to one another.

39. A rotary atomizer for spraying coating agent, having
a) a rotatably mounted hollow shaft for rotating a bell cup, in particular a bell cup according to one of the preceding claims, and
b) a fastening arrangement for fastening of the bell cup to the hollow shaft of the rotary atomizer, in particular for form-fittingly fastening, and
c) the bell cup, which is attached to the hollow shaft of the rotary atomizer,
d) wherein the bell cup is designed according to claim 1.

40. A rotary atomizer according to claim 39, wherein the fastening arrangement comprises, in the hollow shaft of the rotary atomizer, at least one clamping element for bearing against a clamping surface of the bell cup, in order to clamp the bell cup with an axial clamping force on the hollow shaft of the rotary atomizer.

41. The rotary atomizer according to claim 40, wherein
a) the at least one clamping element is a rolling element, and
b) the clamping element has a range of motion in the radial direction in the hollow shaft of the rotary atomizer, and
c) the clamping element in a radially inward clamping position clamps the bell cup on the hollow shaft of the rotary atomizer, and
d) the clamping element in a radially outwardly located release position releases the bell cup in order to enable assembly or disassembly of the bell cup.

42. The rotary atomizer according to claim 41, wherein
a) a cage is provided for radially movably holding the clamping element in the hollow shaft of the rotary atomizer,
b) the cage with the clamping element is arranged in the hollow shaft of the rotary atomizer.

43. The rotary atomizer according to claim 42, wherein
a) the cage is substantially hollow-cylindrical in shape, and
b) the cage is screwed with an external thread into an internal thread of the hollow shaft of the rotary atomizer.

44. The rotary atomizer according to claim 42, wherein
a) a clamping ring is provided for moving the clamping element from the outwardly located release position to the inwardly located clamping position,
b) the clamping ring is arranged in the annular gap between the cage and the hollow shaft of the rotary atomizer,
c) the clamping ring is connected to the hollow shaft of the rotary atomizer by a screw connection, the screw connection having an external thread on the clamping ring and an internal thread in the hollow shaft of the rotary atomizer, so that a rotation of the clamping ring leads to a corresponding axial displacement of the clamping ring in the hollow shaft of the rotary atomizer, and
d) the clamping ring has at its proximal end a clamping surface which is angled with respect to the axis of rotation of the bell cup and widens in the proximal direction, so that the clamping ring, when moving in the proximal direction, presses the clamping element radially inwards into the clamping position.

45. The rotary atomizer according to claim 44, wherein the clamping element is pressed outwardly against the clamping surface of the clamping ring during coating operation when the hollow shaft rotates due to the centrifugal forces occurring and thereby axially braces the screw connection between the clamping ring and the hollow shaft of the rotary atomizer, so that the frictional forces in the screw connection between the clamping ring and the hollow shaft increase with the rotational speed.

46. The rotary atomizer according to claim 44, wherein the driver projects from the clamping ring in the axial distal direction and engages in a receptacle in the hub part of the bell cup, so that the bell cup also rotates the clamping ring during a rotation during assembly or disassembly.

47. The rotary atomizer according to claim 44, wherein
a) in the assembled state of the bell cup a certain axial clamping force acts on the clamping ring,
b) the angled clamping surface of the clamping ring exerts a certain surface-normal clamping force on the clamping element in the assembled state,
c) the clamping surface of the clamping ring is angled to the axis of rotation of the bell cup in such a way that a certain force transmission ratio occurs between the axial clamping force on the clamping ring on the one hand and the surface-normal clamping force on the clamping element on the other hand,
d) the force transmission ratio is at most 1:8 and is greater than 1:1.

48. The rotary atomizer according to claim 44, wherein
a) in the assembled state of the bell cup a certain axial clamping force acts on the clamping ring,
b) in the screw connection between the clamping ring and the hollow shaft a certain frictional force occurs which depends on the axial clamping force on the clamping ring, and
c) the ratio between the frictional force on the one hand and the axial clamping force on the clamping ring on the other hand is at least 0.5:1 and at most 1:6.

49. The rotary atomizer according to claim 42, wherein
a) the cage contains several pairs of clamping elements distributed over the circumference, and
b) the pairs of clamping elements are evenly distributed over the circumference, and
c) the number of pairs of clamping elements is equal to three, and
d) the distance between the clamping elements within a pair is smaller than the distance between the clamping elements of adjacent pairs, and
e) the at least one clamping element is made of steel, ceramic, plastic or glass, and
f) the at least one clamping element has a diameter which is in the range of 1 mm-5 mm, and
g) the number of clamping elements is three, four, five, six, seven, eight, nine, ten, eleven or twelve.

50. The rotary atomizer according to claim 41, wherein
a) the at least one clamping element of the fastening arrangement in the hollow shaft of the rotary atomizer on the one hand and the clamping surface of the bell cup on the other hand consist of different materials,
b) the at least one clamping element of the fastening arrangement in the hollow shaft of the rotary atomizer consists of ceramic,
c) the clamping surface of the bell cup is made of steel.

51. The rotary atomizer according to claim 44, wherein the clamping connection between the angled clamping surface of the clamping ring on the one hand and the clamping element on the other hand is self-locking.

52. The rotary atomizer according to claim 44, wherein the clamping ring has an undulating section in longitudinal section in order to make the clamping ring elastically compliant in the axial direction.

53. The rotary atomizer according to claim 40, wherein
a) the threaded connections of the fastening arrangements each have a right-hand thread, and
b) the rotary atomizer is designed to rotate the hollow shaft to the left during coating operation, so that a deceleration and a blockade of the rotary movement of the hollow shaft leads to tightening of the right-hand threads of the threaded connections.

54. The rotary atomizer according to claim 40, wherein
a) the hub part of the bell cup has a cylindrical outer surface, and
b) the cylindrical outer surface of the hub part forms an inner boundary wall of the outer rinsing chamber, and
c) the hollow shaft of the rotary atomizer has a cylindrical outer surface, and
d) the cylindrical outer surface of the hollow shaft of the rotary atomizer forms an inner boundary wall of the outer rinsing chamber, and
e) the cylindrical outer surface of the hollow shaft merges into the cylindrical outer surface of the hub part essentially without a step.
